(19) United States
(12) Patent Application Publication
(10) Pub. No.: US 2026/0222068 A1
(43) Pub. Date: Jul. 30, 2026

(54) COMMUNICATION SYSTEM, COMMUNICATION METHOD, CONTROL DEVICE, AND PROGRAM

(71) Applicant: NTT, Inc., Tokyo (JP)

(72) Inventors: Kiwami INOUE, Musashino-shi, Tokyo (JP); Takeru INOUE, Musashino-shi, Tokyo (JP); Hideki NISHIZAWA, Musashino-shi, Tokyo (JP); Kazuaki OBANA, Musashino-shi, Tokyo (JP); Toru MANO, Musashino-shi, Tokyo (JP); Tsuyoshi OGURA, Musashino-shi, Tokyo (JP); Junki ICHIKAWA, Musashino-shi, Tokyo (JP); Takeshi KUGIMOTO, Musashino-shi, Tokyo (JP); Tomonori MAEKAWA, Musashino-shi, Tokyo (JP); Takeshi KINOSHITA, Musashino-shi, Tokyo (JP); Tatsuya MATSUMURA, Musashino-shi, Tokyo (JP); Koki YUBE, Musashino-shi, Tokyo (JP); Kazuya ANAZAWA, Musashino-shi, Tokyo (JP); Koichi TAKASUGI, Musashino-shi, Tokyo (JP)

(73) Assignee: NTT, Inc., Tokyo (JP)

(21) Appl. No.: 19/143,922

(22) PCT Filed: Jan. 19, 2023
(86) PCT No.: PCT/JP2023/001580

§ 371 Date: Jun. 27, 2025

(51) Int. Cl. H04B 10/27

(52) U.S. Cl. CPC H04B 10/27

(57) ABSTRACT

In a case where a computing resource to be moved operating in a first data center is moved to a second data center, a control device includes a path establishment support unit that specifies a wavelength available in a first data center, a cross connect, and a second data center, and notifies the first data center, the cross connect, and the second data center of the specified wavelength. An optical path from the first data center through the cross connect to the second data center is established at the specified wavelength. The first data center moves the computing resource to be moved using the optical path established from the first data center to the second data center.

### TECHNICAL FIELD

The present disclosure relates to a communication system, a communication method, a control device, and a program.

BACKGROUND ART

Cloud providers having data centers in a plurality of locations may consider moving computing resources. For example, cloud providers may consider moving computing resources to data centers closer to clients to minimize a delay, moving computing resources to data centers in cold weather regions, or operating at night to reduce cooling costs, or the like (Non-Patent Literature 1).

### CITATION LIST

### Non-Patent Literature

Non-Patent Literature: Fei Zhang, and three others, “A Survey on Virtual Machine Migration: Challenges, Techniques, and Open Issues”, 2018, IEEE COMMUNICATIONS SURVEYS & TUTORIALS, VOL. 20, NO. 2, SECOND QUARTER 2018

### SUMMARY OF INVENTION

### Technical Problem

However, it may be difficult to move computing resources in response to sudden factors such as a sudden disaster, shortage of power, and rise in electricity costs in an area where a data center is located. For example, Non-Patent Literature 1 does not have a scheme for immediately moving computing resources such as a virtual machine (VM) or a database to another data center. When additional traffic occurs with the movement of resources, a router (or a switch) within the data center suffers from a bottleneck. It is difficult to move resources without influencing normal traffic.

In addition, Non-Patent Literature 1 does not disclose a method of determining a movement destination of a resource, and is unable to allocate the movement destination in response to a request required for the resource such as an application.

The present disclosure is made in view of such circumstances, and an object of the present disclosure is to provide a technique that makes it possible to move computing resources, as appropriate.

### Solution to Problem

According to an aspect of the present disclosure, there is provided a communication system comprising: a plurality of data centers; a wavelength cross connect configured to connect each data center through an optical path; and a control device connected to each of the plurality of data centers and the wavelength cross connect, in which, in a case where a computing resource to be moved operating in a first data center is moved to a second data center, the control device includes a path establishment support unit configured to specify a wavelength available in the first data center, the wavelength cross connect, and the second data center, and to notify the first data center, the wavelength cross connect, and the second data center of a specified wavelength, the communication system establishes an optical path from the first data center through the wavelength cross connect to the second data center at the specified wavelength, and the first data center moves the computing resource to be moved using the optical path established from the first data center to the second data center.

According to an aspect of the present disclosure, there is provided a communication method used in a communication system including: a plurality of data centers; a wavelength cross connect configured to connect each data center through an optical path; and a control device connected to each of the plurality of data centers and the wavelength cross connect, in which, in a case where a computing resource to be moved operating in a first data center is moved to a second data center, the control device specifies a wavelength available in the first data center, the wavelength cross connect, and the second data center and notifies the first data center, the wavelength cross connect, and the second data center of a specified wavelength, an optical path from the first data center through the wavelength cross connect to the second data center is established at the specified wavelength, and the first data center moves the computing resource to be moved using the optical path established from the first data center to the second data center.

According to an aspect of the present disclosure, there is provided a control device including: a storage device configured to store power data related to power consumed by each data center; optical link data for associating a transmission delay and maximum capacity of an optical link between data centers; and computing resource data for associating a delay request and a data capacity for each computing resource; an acquisition unit configured to acquire an identifier of a computing resource to be moved; and a determination unit configured to refer to the optical link data and the computing resource data and to determine, from among candidates for data centers that are movement destinations of the computing resource to be moved, a data center that is a movement destination in which requirements for a transmission delay and a maximum capacity of an optical link from a data center accommodating the computing resource to be moved to the data center which is a movement destination satisfy requirements for a delay request and a data capacity of the computing resource to be moved, and in which a power consumption index at the data center that is a movement destination is the best.

According to an aspect of the present disclosure, there is provided a program for causing a computer to function as the control device described above.

### Effects of Invention

According to the present disclosure, it is possible to provide a technique that makes it possible to move computing resources appropriately.

### BRIEF DESCRIPTION OF DRAWINGS

FIG. 1 is a diagram illustrating a system configuration of a communication system according to an embodiment of the present disclosure.

FIG. 2 is a block diagram illustrating a configuration of a first data center.

FIG. 3 is a block diagram illustrating a configuration of a second data center.

FIG. 4 is a block diagram illustrating a configuration of a third data center.

FIG. 5 is a diagram illustrating functional blocks of a control device.

FIG. 6 is a diagram illustrating an example of a data structure of power data and the data.

FIG. 7 is a diagram illustrating an example of a data structure of optical link data and the data.

FIG. 8 is a diagram illustrating an example of a data structure of computing resource data and the data.

FIG. 9 is a diagram illustrating an example of a data structure of equipment data and the data.

FIG. 10 is a sequence diagram illustrating a communication method according to an embodiment of the present disclosure.

FIG. 11 is a sequence diagram illustrating a process of establishing an optical path within the first data center.

FIG. 12 is a sequence diagram illustrating a process of establishing an optical path within the second data center.

FIG. 13 is a sequence diagram illustrating a process of preparing to establish an optical path between the first data center and the second data center.

FIG. 14 is a sequence diagram illustrating a communication method according to a modification example.

FIG. 15 is a diagram illustrating a hardware configuration of a computer used in the control device.

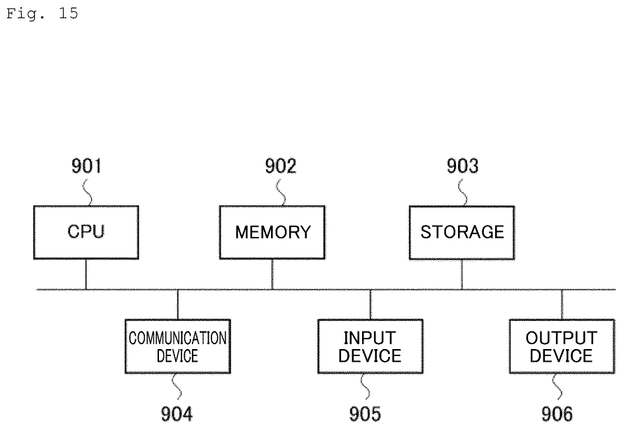

### DESCRIPTION OF EMBODIMENTS

Hereinafter, an embodiment of the present disclosure will be described with reference to the accompanying drawings. In the drawings, the same portions are denoted by the same reference numerals and signs, and the description thereof will be omitted.

### Communication System

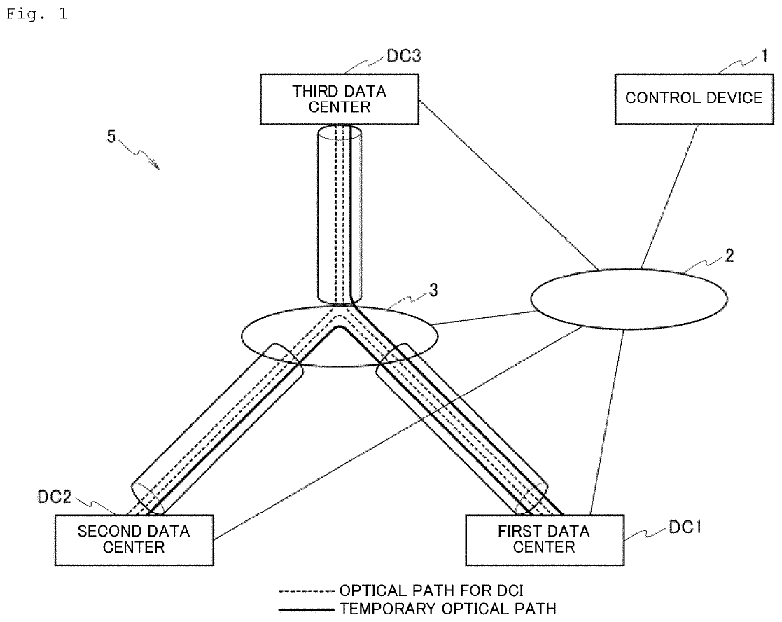

As shown in FIG. 1, a communication system 5 includes a plurality of data centers, a wavelength cross connect 3 that connects each data center to an optical path, and a control device 1 that connects each of the plurality of data centers to the wavelength cross connect 3. The communication system 5 shown in FIG. 1 includes three data centers, that is, a first data center DC1, a second data center DC2, and a third data center DC3, but the number of data centers need only be two or more. In addition, a terminal (not shown) of a user who uses the resource of each data center can be connected to any of the data centers.

The control device 1 is connected to the first data center DC1, the second data center DC2, the third data center DC3, and the wavelength cross connect 3 through a communication network 2 to enable communication between them. The control device 1 transmits an instruction and an inquiry for moving a computing resource to each data center and the wavelength cross connect 3 through the communication network 2.

In the present disclosure, the computing resource is a resource that operates in each data center and can be moved to another data center. The computing resource may be data referred to by a program or may be data which is being executed by a computer. The computing resource may be an application which is running as a virtual machine. In the present disclosure, the computing resource may be denoted as an application or APP (Application).

The first data center DC1 is a computer system that includes a plurality of computers and transmits and receives data to and from computers inside and outside the data center or processes the data by using the optical path for DCI. The second data center DC2 and the third data center DC3 are the same as the first data center DC1. The first data center DC1, the second data center DC2, and the third data center DC3 may be provided at positions different from each other. For example, in a case where the first data center DC1 is affected by a disaster or suffers from an increase in the processing load or power costs, the computing resource operating in the first data center DC1 can be moved to another data center.

The wavelength cross connect 3 exchanges optical paths in units of wavelengths. The wavelength cross connect 3 may be referred to as a WXC (wavelength cross connect). In the communication system 5, the wavelength cross connect 3 exchanges optical paths between the first data center DC1 and the second data center DC2, between the second data center DC2 and the third data center DC3, and between the first data center DC1 and the third data center DC3. The wavelength cross connect realizes the technique disclosed in Japanese Patent No. 5398839.

In the communication system 5, optical paths for data center interconnect (DCI) are always provided between the data centers through the wavelength cross connect 3.

In the present disclosure, when a computing resource operating a certain data center is moved to another data center, a temporary optical path connecting the data centers is further established under control of the control device 1. In the communication system 5 shown in FIG. 1, in a case where a plurality of computing resources are operating in the first data center DC1 and the first data center DC1 cannot operate due to a disaster or the like, a temporary optical path is established between the first data center DC1 and the second data center DC2, and a temporary optical path is established between the first data center DC1 and the third data center DC3. The temporary optical path is opened when the movement of the computing resource is completed.

### Data Center

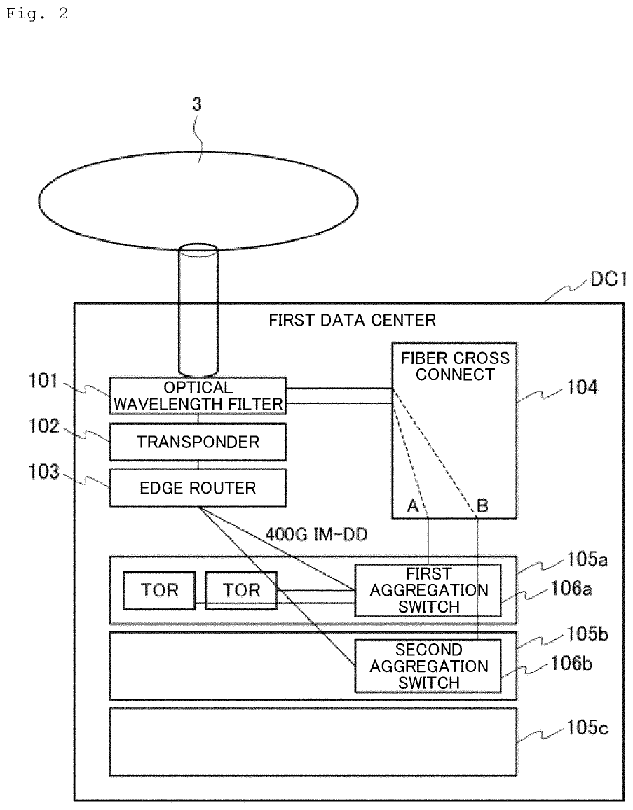

The first data center DC1 will be described with reference to FIG. 2. The first data center DC1 is a processing system including an optical wavelength filter 101, a transponder 102, an edge router 103, a fiber cross connect 104, a first server group 105a, a second server group 105b, and a third server group 105c.

The first server group 105a includes a first aggregation switch 106a connected to each server. The second server group 105b includes a second aggregation switch 106b connected to each server. The same applies to the third server group 105c.

The optical wavelength filter 101 wavelength-multiplexes and outputs a DWDM (dense wavelength division multiplexing) signal (optical signal) output by the transponder 102 and the aggregation switch 106a or 106b without signal conversion. In addition, the optical wavelength filter 101 acquires a DWDM signal of a predetermined wavelength from the input signal, and outputs the signal to the transponder 102 and the aggregation switch 106a or 106b. The optical wavelength filter 101 may be referred to as a AMUX.

The transponder 102 converts and relays a signal between the optical wavelength filter 101 and the edge router 103. The transponder 102 converts the electrical signal acquired from the edge router 103 into an optical signal and inputs it to the optical wavelength filter 101. The transponder 102 converts the optical signal input from the optical wavelength filter 101 into an electrical signal and inputs it to the edge router 103.

The edge router 103 transmits and receives the electrical signal between the transponder 102 and each server group. Data is transmitted and received between the edge router 103 and each server group using a 400G IM-DD scheme. The edge router 103 inputs the electrical signal input from the transponder 102 to the first aggregation switch 106a or the second aggregation switch 106b, or inputs the electrical signal input from the first aggregation switch 106a or the second aggregation switch 106b to the transponder 102.

The fiber cross connect 104 outputs the optical signal input from an input port to an output port. The fiber cross connect 104 may be referred to as an FXC. The fiber cross connect 104 in the first data center DC1 has a port A and a port B. The port A is connected to the first aggregation switch 106a. The port B is connected to the second aggregation switch 106b. The fiber cross connect 104 outputs a plurality of optical signals having different wavelengths to each of a plurality of output ports. For example, the fiber cross connect 104 inputs and outputs an optical signal of a wavelength transmitted and received to and from the first aggregation switch 106a which is a connection destination of the port A to and from the port A. The fiber cross connect 104 inputs and outputs an optical signal of a wavelength transmitted and received to and from the second aggregation switch 106b which is a connection destination of the port B to and from the port B.

The first aggregation switch 106a transmits and receives an electrical signal to and from the edge router 103 through a digital analog converter (DAC) cable, and transmits and receives an optical signal to and from the fiber cross connect 104. The first aggregation switch 106a converts the electrical signal acquired from a server group into an optical signal to transmit the optical signal to the fiber cross connect 104, and converts the optical signal received from the fiber cross connect 104 into an electrical signal to transmit the electrical signal to the server group.

The first aggregation switch 106a has, for example, a function of a coherent transceiver capable of long-distance transmission. The coherent transceiver converts an optical signal of a predetermined wavelength received from the fiber cross connect 104 through an optical fiber into an electrical signal. The first aggregation switch 106a has a function of a module-type coherent transceiver such as QSFP-DD, and uses this function to establish an optical path for moving the computing resource to be moved. The first aggregation switch 106a puts the function of the module-type coherent transceiver on standby when normal traffic occurs, and operates when an optical path for moving a computing resource is established.

A signal of an optical path for DCI which is always connected is input and output from the optical wavelength filter 101 through the transponder 102 and the edge router 103 to the first aggregation switch 106a or the second aggregation switch 106b. In a case where a computing resource is moved, a signal on a temporary optical path is input and output from the optical wavelength filter 101 through the fiber cross connect 104 to the first aggregation switch 106a and the second aggregation switch 106b.

The optical wavelength filter 101 extracts an optical signal of a wavelength used in an optical path for DCI which is always connected from the received optical signal, and inputs the extracted optical signal to the transponder 102. The optical wavelength filter 101 extracts an optical signal of a wavelength used in a temporary optical path for moving a computing resource, and inputs the extracted optical signal to the fiber cross connect 104. The optical wavelength filter 101 outputs the optical signal input to the first aggregation switch 106a to a port connected to the port A of the fiber cross connect 104. The optical wavelength filter 101 outputs the optical signal input to the second aggregation switch 106b to a port connected to the port B of the fiber cross connect 104.

Within the data center, a route for processing traffic that normally occurs and a route for processing temporary traffic for moving a computing resource are distinguished from each other. The data center can move the computing resource without influencing the traffic that normally occurs.

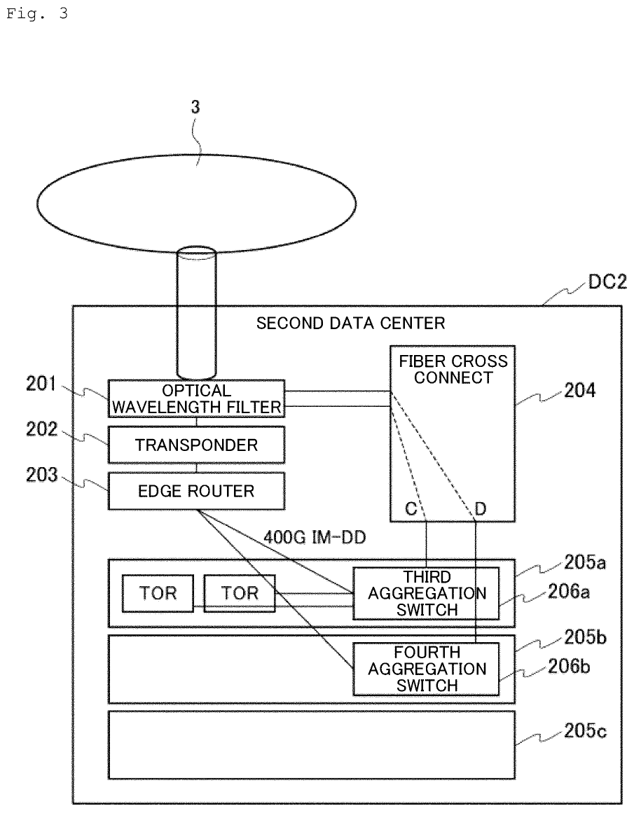

The second data center DC2 will be described with reference to FIG. 3. The second data center DC2 has the same configuration as the first data center DC1.

In the second data center DC2, a first server group 205a includes a third aggregation switch 206a connected to each server. A second server group 205b includes a fourth aggregation switch 206b connected to each server. The same applies to a third server group 205c.

A fiber cross connect 204 in the second data center DC2 has a port C and a port D. The port C is connected to the third aggregation switch 206a. The port D is connected to the fourth aggregation switch 206b. The fiber cross connect 204 inputs and outputs an optical signal of a wavelength transmitted and received to and from the third aggregation switch 206a which is a connection destination of the port C to and from the port C. The fiber cross connect 204 inputs and output an optical signal of a wavelength transmitted and received to and from the fourth aggregation switch 206b which is a connection destination of the port D to and from the port D.

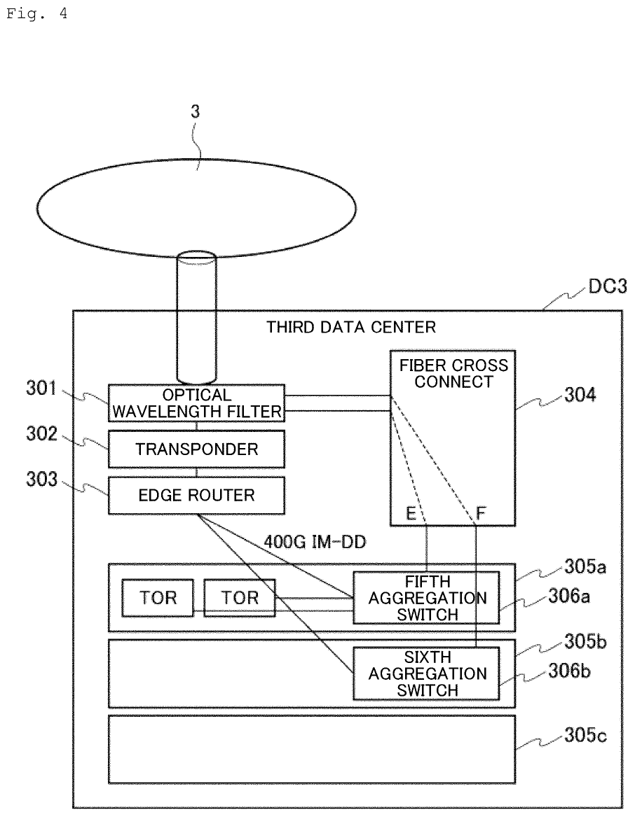

The third data center DC3 will be described with reference to FIG. 4. The third data center DC3 has the same configuration as the first data center DC1.

In the third data center DC3, a first server group 305a includes a fifth aggregation switch 306a connected to each server. A second server group 305b includes a sixth aggregation switch 306b connected to each server. The same applies to a third server group 305c.

A fiber cross connect 304 of the third data center DC3 has a port E and a port F. The port E is connected to the fifth aggregation switch 306a. The port F is connected to the sixth aggregation switch 306b. The fiber cross connect 304 inputs and outputs an optical signal of a wavelength transmitted and received to and from the fifth aggregation switch 306a which is a connection destination of the port E to and from the port E. The fiber cross connect 104 inputs and outputs an optical signal of a wavelength transmitted and received to and from the sixth aggregation switch 306b which is a connection destination of the port F to and from the port F.

### Control Device

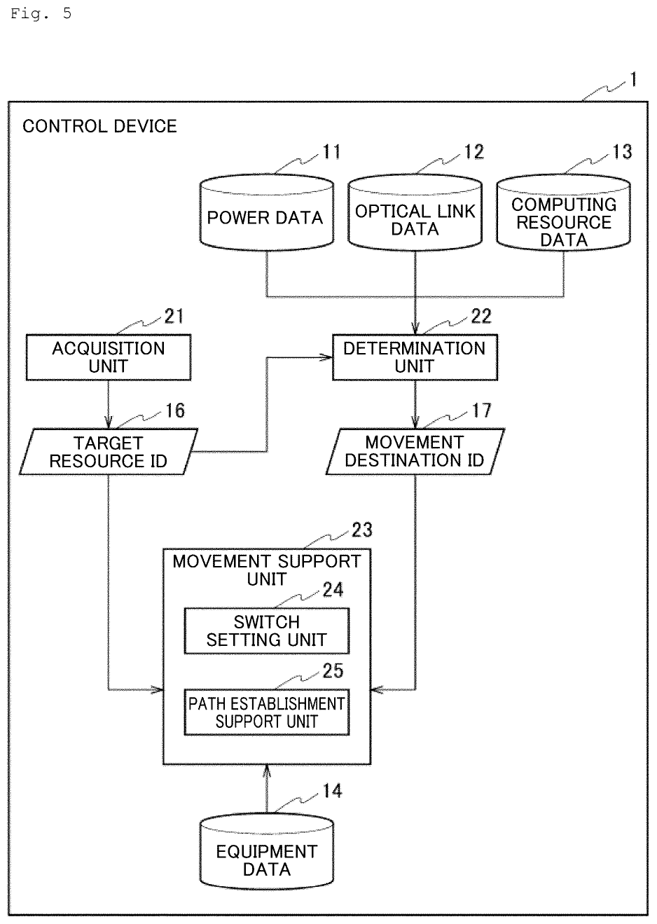

As shown in FIG. 5, the control device 1 includes each piece of data of power data 11, optical link data 12, computing resource data 13, equipment data 14, a target resource ID 16, and a movement destination ID 17, and includes each of the functions of an acquisition unit 21, a determination unit 22, and a movement support unit 23. Each piece of data is stored in a storage device such as a memory 902 or a storage 903. Each function is implemented in a CPU 901. The control device 1 may have a function of inquiring each piece of data such as the power data 11, the optical link data 12, the computing resource data 13, and the equipment data 14 from each data center or the like and holding the latest information.

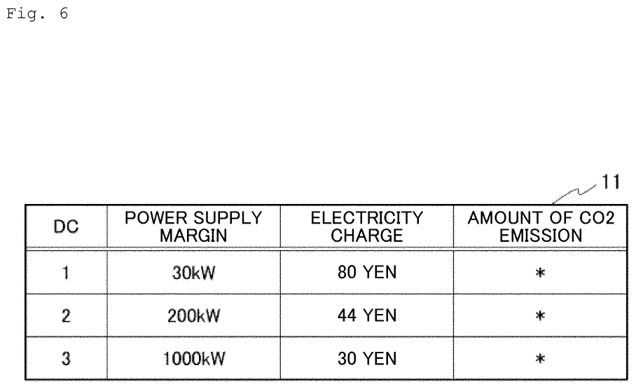

The power data 11 is data relating to the power consumed by each data center. As shown in FIG. 6, the power data 11 associates the identifier of a data center with each piece of data such as the power supply capacity, the electricity charge, and the amount of CO2 emission as information relating to the power in the data center.

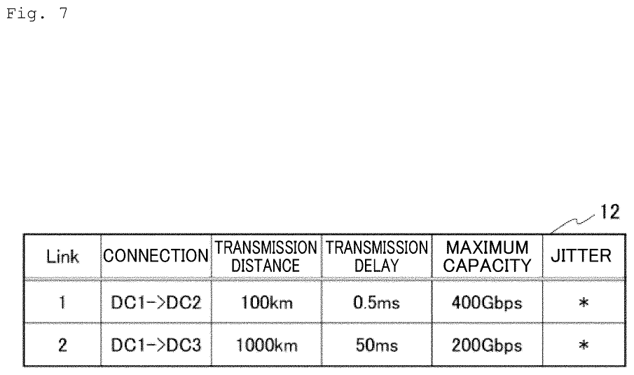

The optical link data 12 is data for associating the transmission delay, maximum capacity, and the like of the optical link between data centers. The optical link data 12 specifies the specification of an optical link composed of an optical path which is temporarily established under control of the control device 1. As shown in FIG. 7, the optical link data 12 associates data such as transmission distance, transmission delay, maximum capacity, and jitter for each of a first optical link from the first data center DC1 to the second data center DC2 and a second optical link from the first data center DC1 to the third data center DC3. The optical link data 12 may also specify the specification of a third optical link for moving a computing resource between the second data center DC2 and the third data center DC3.

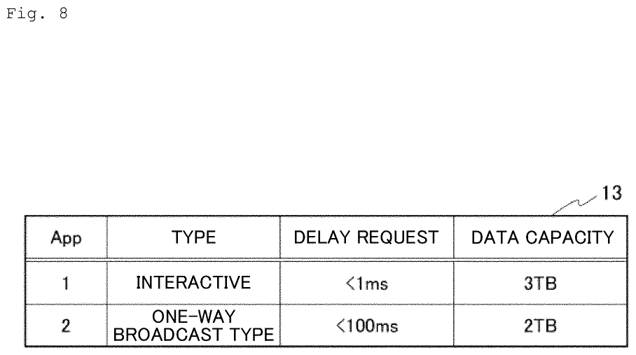

The computing resource data 13 specifies the delay and data capacity required by a user who uses each computing resource. The computing resource data 13 associates the delay request and data capacity for each computing resource. As shown in FIG. 8, the computing resource data 13 may associate each computing resource with each piece of data such as the type of the computing resource, delay request, and data capacity.

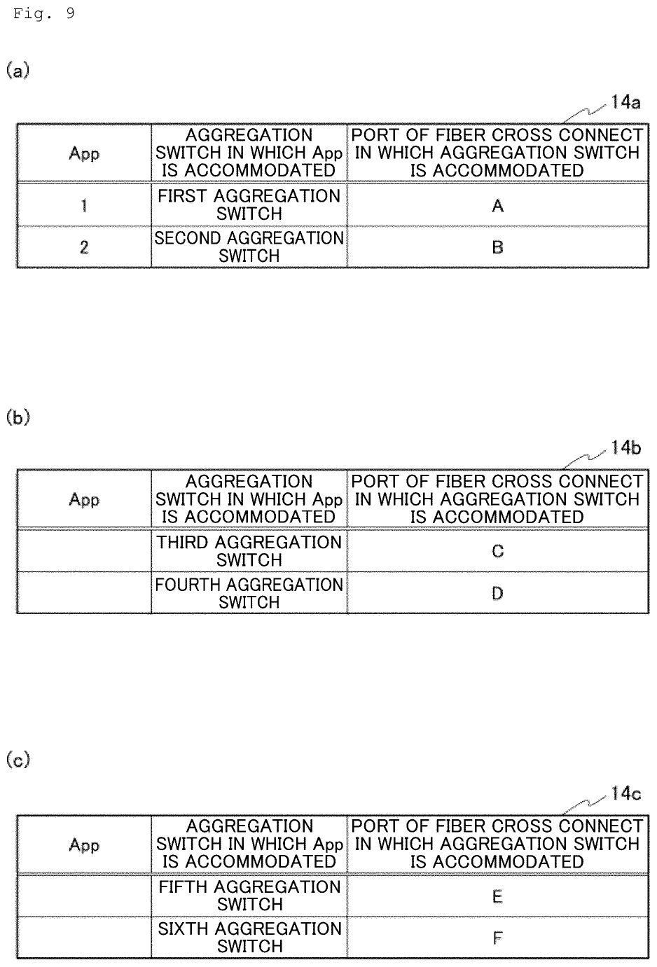

The equipment data 14 is data indicating the relationship between the computing resources, the aggregation switches, and the ports in each data center. As shown in FIG. 9, the equipment data 14 associates the identifier of a data center, the identifier of a computing resource (App) operating in the data center, the identifier of an aggregation switch connected to a server that accommodates each computing resource, and the identifier of a port of a fiber cross connect connected to each aggregation switch. FIG. 9(a) shows the equipment data 14a indicating the relationship between the computing resource, the aggregation switch, and the port in the first data center DC1. FIG. 9(b) shows the equipment data 14b indicating the relationship between the computing resource, the aggregation switch, and the port in the second data center DC2. FIG. 9(c) shows the equipment data 14c indicating the relationship between the computing resource, the aggregation switch, and the port in the third data center DC3.

The target resource ID 16 is an identifier of a computing resource to be moved. The target resource ID is acquired by the acquisition unit 21 from each data center. The target resource ID 16 may specify a plurality of computing resource IDs.

The movement destination ID 17 is an identifier of a data center which is a movement destination of a computing resource to be moved. In a case where the target resource ID specifies a plurality of computing resource IDs, the movement destination ID 17 associates the movement destination with each computing resource to be moved.

The acquisition unit 21 acquires the identifier of a computing resource to be moved. For example, when the first data center DC1 is affected by a disaster, the first data center DC1 notifies the control device 1 of the identifier of a computing resource operating in the first data center DC1. The acquisition unit 21 stores the identifier of the computing resource notified of by the first data center DC1 as the target resource ID 16.

The determination unit 22 determines a data center which is a movement destination for each of the computing resources to be moved, which are specified by the target resource ID 16, and records it in the movement destination ID 17. The determination unit 22 determines the data center which is a movement destination using the ability to realize the request for the computing resource to be moved as a constraint condition and using an index related to power consumption in the data center as an evaluation function.

The determination unit 22 first specifies candidates for data centers which are movement destinations for the computing resources to be moved. Here, data centers other than the data center in which the computing resource to be moved is in operation are candidates. The determination unit 22 may exclude, from the candidates, a data center that does not have a server capable of accommodating the computing resource to be moved.

The determination unit 22 refers to the optical link data 12 and the computing resource data 13 to determine a data center which is a movement destination that satisfies both the following two conditions from among the candidate of data centers which are movement destinations for the computing resources to be moved.
(i) Requirements for the transmission delay and maximum capacity of the optical link from the data center that accommodates the computing resource to be moved to the data center which is a movement destination satisfy requirements for the delay request and data capacity of the computing resource to be moved, and
(ii) A power consumption index at the data center which is a movement destination is the best.

The above requirement (i) indicates that a request required for the computing resource can be realized even in the data center which is a movement destination. The above requirement (ii) indicates that, in a case where there are candidates for a plurality of data centers in the requirement (i), an index related to power consumption is the best among the candidates. There are various indexes related to power consumption such as, for example, leveling out the power supply margin in each data center, minimizing the power charge, and minimizing the amount of CO2 emission. The determination unit 22 may select a data center with the best index among these indexes, or may select a data center with the best index obtained from the plurality of indexes.

For example, in the computing resource data 13 shown in FIG. 8, App1 has a delay request of 1 ms or less and a data capacity of 3 TB. In the optical link data 12 shown in FIG. 7, the optical link from the first data center DC1 to the third data center DC3 can accommodate the data capacity of Appl, but does not satisfy the delay request of Appl because the transmission delay is 50 ms. By contrast, the optical link from the first data center DC1 to the second data center DC2 having a transmission delay of 0.5 ms satisfies the delay request of Appl and can also accommodate the data capacity of App1. Therefore, the determination unit 22 specifies the movement destination of App1 as the first data center DC1.

In addition, in the computing resource data 13 shown in FIG. 8, App2 has a delay request of 100 ms or less and a data capacity of 2 TB. In the optical link data 12 shown in FIG. 7, both optical link from the first data center DC1 to the third data center DC3 and the optical link from the first data center to the third data center DC3 satisfy the delay request of App2 and can also accommodate the data capacity of App2. Therefore, the determination unit 22 determines a data center with the best predetermined power index out of either the second data center DC2 or the third data center DC3 as the data center which is a movement destination.

The movement support unit 23 supports the establishment of a temporary optical path for moving a computing resource to be moved to the data center which is a movement destination. The movement support unit 23 includes a switch setting unit 24 and a path establishment support unit 25.

The optical paths for moving the computing resource to be moved are (1) an optical path from the aggregation switch to which the server accommodating the computing resource is connected in the data center which is a movement source to the optical wavelength filter, (2) an optical path from the data center which is a movement source to the data center which is a movement destination, and (3) an optical path from the optical wavelength filter to the aggregation switch to which the server accommodating the computing resource is connected in the data center which is a movement destination.

The switch setting unit 24 sets the switches of the fiber cross connect in order to establish the optical paths of the above (1) and (3). The path establishment support unit 25 notifies the data centers which are a movement source and movement destination and the wavelength cross connect of the settings for establishing the optical path of the above (2), and supports the establishment of an optical path from the data center which is a movement source to the data center which is a movement destination.

The optical path of the above (1) is newly established by the first data center DC1 within the first data center DC1 in addition to the path for normal DCI in order to move the computing resource to be moved operating in the first data center DC1 to second data center. When the computing resource to be moved is moved through the newly established optical path, the first data center DC1 opens the newly established optical path. The optical path is opened by stopping transmission and reception of an optical signal at the output port of the fiber cross connect 104, putting the coherent transceiver function in the aggregation switch on standby, or the like.

The optical path of the above (3) is newly established by the second data center DC2 within the second data center DC2 in addition to the path for normal DCI in order to move the computing resource to be moved operating in the first data center DC1 to second data center. When the computing resource to be moved is moved through the newly established optical path, the second data center DC2 opens the newly established optical path. The optical path is opened by stopping transmission and reception of an optical signal at the output port of the fiber cross connect 204, putting the coherent transceiver function in the aggregation switch on standby, or the like.

In the present disclosure, a case where the computing resource operating in the first data center DC1 is moved to the second data center DC2 will be described. The computing resource to be moved is a first APP, which is accommodated in a server to which the first aggregation switch 106a of the first data center DC1 is connected before the movement. The computing resource to be moved is accommodated in a server to which the third aggregation switch 206a of the second data center DC2 is connected after the movement.

In order to establish the optical path of the above (1), the switch setting unit 24 transmits, to the first data center DC1, an instruction for connection to the output port A connected to the first aggregation switch 106a to which a server accommodating the computing resource to be moved is connected, among the output ports of the fiber cross connect 104 of the first data center DC1.

When the first data center DC1 receives the instruction for connection from the control device 1, the fiber cross connect 104 connects the port A connected to the first aggregation switch 106a, to which a server accommodating the computing resource to be moved is connected, to the first aggregation switch 106a. The first data center DC1 establishes an optical path between the optical wavelength filter 101 and the first aggregation switch 106a connected to a server accommodating the computing resource to be moved.

In order to establish the optical path of the above (3), the switch setting unit 24 transmits, to the second data center DC2, an instruction for connection to the output port C connected to the third aggregation switch 206a to which a server accommodating the computing resource to be moved is connected, among the output ports of the fiber cross connect 204.

When the second data center DC2 receives the instruction for connection from the control device 1, the fiber cross connect 204 of the second data center DC2 connects the output port C, connected to the third aggregation switch 206a of the server in which the computing resource to be moved is accommodated, to the third aggregation switch 206a. The second data center DC2 establishes an optical path between an optical wavelength filter 201 and the third aggregation switch 206a connected to a server in which the computing resource to be moved is accommodated.

In order to establish the optical path of the above (2), the path establishment support unit 25 specifies wavelengths available in the first data center DC1, the wavelength cross connect 3, and the second data center DC2. The path establishment support unit 25 notifies the first data center DC1, the wavelength cross connect 3, and the second data center DC2 of the specified wavelength. In this case, the path establishment support unit 25 may notify of setting information for the optical path of the above (2), specifically, the modulation method, rate, forward error correction (FEC) setting, and the like.

Here, the available wavelength is, for example, a free wavelength which is not used by other optical paths. Alternatively, the available wavelength is a wavelength which is used by other optical paths and has room to move the resource to be moved.

When the wavelength specified by the control device 1 is notified of, the first data center DC1 establishes an optical path from the first data center DC1 through the wavelength cross connect 3 to the second data center DC2 at the specified wavelength.

When the optical paths of the above (1) to (3) are established, the first data center DC1 moves the computing resource to be moved using the optical path established within the first data center DC1, the optical path established from the first data center DC1 to the second data center DC2, and the optical path established within the second data center DC2. When the movement of the computing resource to be moved is completed, the optical path established within the first data center DC1, the optical path established from the first data center DC1 to the second data center DC2, and the optical path established within the second data center DC2 are opened.

### Communication Method

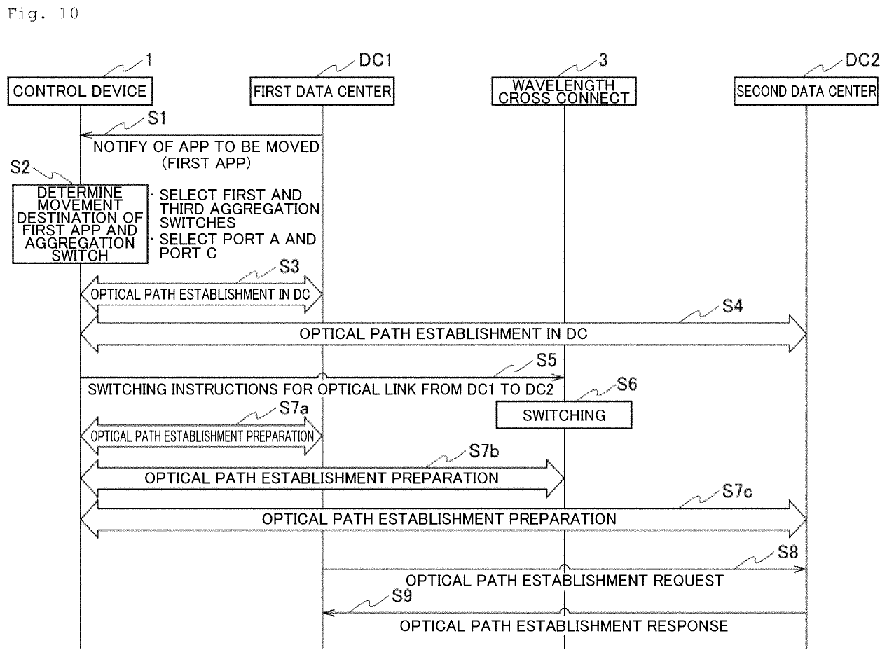

The processing of the communication system 5 in the present disclosure will be described with reference to FIGS. 10 to 13.

First, the processing a communication method according to an embodiment of the present disclosure will be described with reference to FIG. 10.

In step S1, the first data center DC1 notifies the control device 1 of an application to be moved. The application to be moved is referred to as a first APP.

In step S2, the control device 1 determines a data center which is a movement destination of the first APP and an aggregation switch to be connected to a server in the data center which is its movement destination. Here, the control device 1 sets the movement destination as the second data center DC2. The control device 1 selects the first aggregation switch 106a as the aggregation switch which is a movement source and the third aggregation switch 206a as the aggregation switch which is a movement destination. In addition, the control device 1 selects the port A and the port C. The port A is a port of the fiber cross connect 104 connected to the first aggregation switch 106a. The port C is a port of the fiber cross connect 204 connected to the third aggregation switch 206a.

In step S3, the control device 1 causes the first data center DC1 to establish an optical path. In step S4, the control device 1 causes the second data center DC2 to establish an optical path.

In step S5, the control device 1 transmits, to the wavelength cross connect 3, an instruction to switch the optical link from the first data center DC1 to the second data center DC2. With this switching instruction, a signal transmitted from the first data center DC1 is transmitted to the second data center DC2. In step S6, the wavelength cross connect 3 switches the optical link from the first data center DC1 to the second data center DC2.

In steps S7a, S7b, and S7c, preparation for establishing an optical path between data centers is performed. In step S8, the first data center DC1 requests the second data center DC2 to establish an optical path. In step S9, the second data center DC2 responds to the first data center DC1 to establish an optical path. This causes an optical path to be established between the first data center DC1 and the second data center DC2.

The first data center DC1 moves the first APP from the first data center DC1 to the second data center DC2. The first APP is moved using the optical path within the first data center DC1 established in step S3, the optical path between the first data center DC1 and the second data center DC2 established in step S9, and the optical path within the second data center DC2 established in step S4.

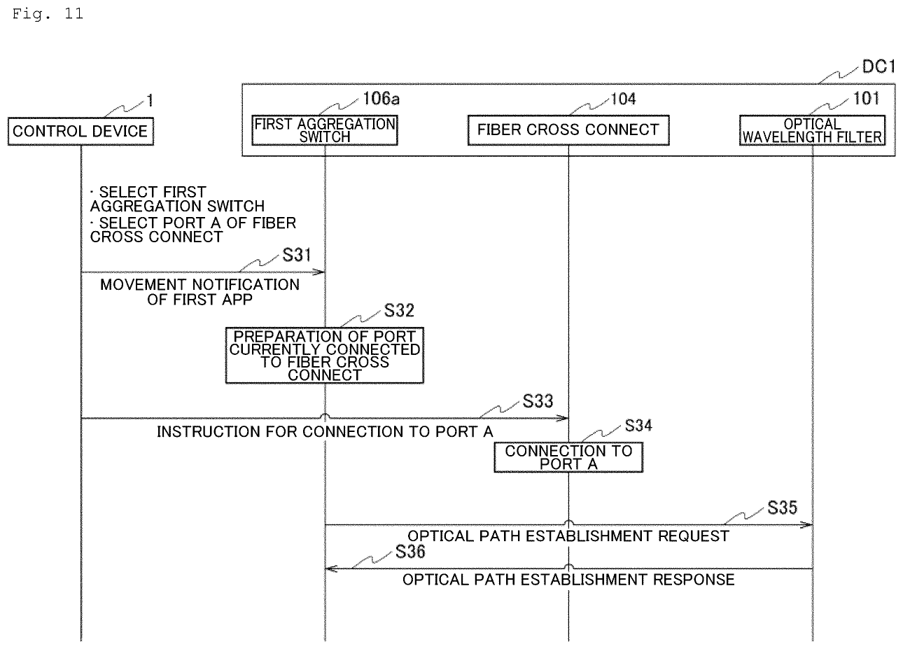

A process of establishing an optical path within the first data center DC1 will be described with reference to FIG. 11. This process corresponds to the process of step S3 in FIG. 10.

In step S31, the control device 1 notifies the first aggregation switch 106a of the first data center DC1 of the movement of the first APP. In step S32, the first aggregation switch 106a prepares the port currently connected to the fiber cross connect 104. Specifically, the process at the port currently connected to the fiber cross connect 104 ends, and the port is opened.

In step S33, the control device 1 transmits an instruction for connection to the port A to the fiber cross connect 104 of the first data center DC1. In step S34, the fiber cross connect 104 connects the port A to the first aggregation switch 106a.

In step S35, the first aggregation switch 106a requests the optical wavelength filter 101 to establish an optical path. In step S36, the optical wavelength filter 101 responds to the first aggregation switch 106a to establish an optical path. Through the processing of FIG. 11, an optical path is established within the first data center DC1 under control of the control device 1.

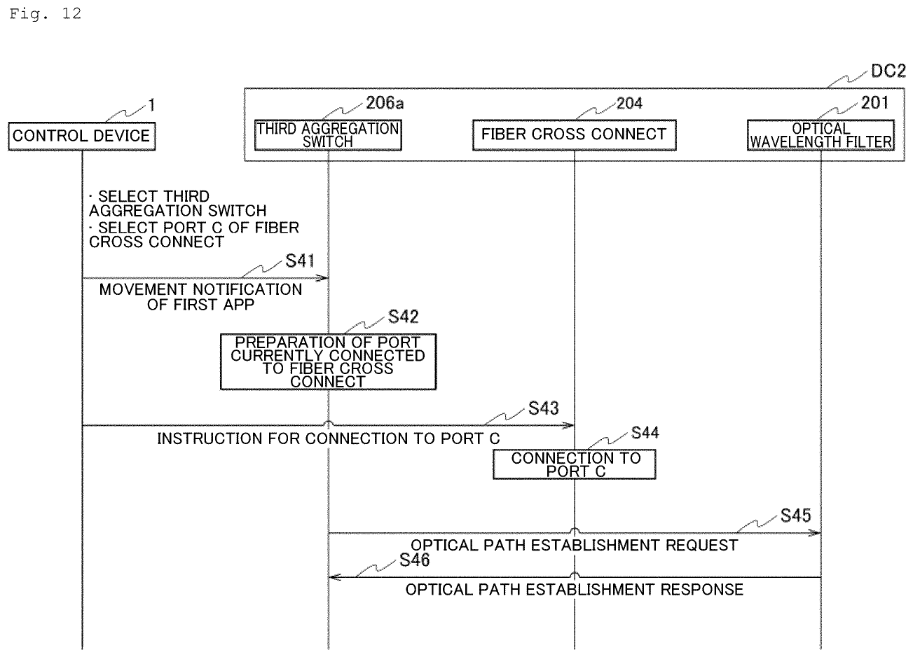

A process of establishing an optical path within the second data center DC2 shown in FIG. 12 is the same as the process of establishing an optical path within the first data center DC1 described with reference to FIG. 11. This process corresponds to the process of step S4 in FIG. 10. Through the process of FIG. 12, an optical path is established with the second data center DC2 under control of the control device 1.

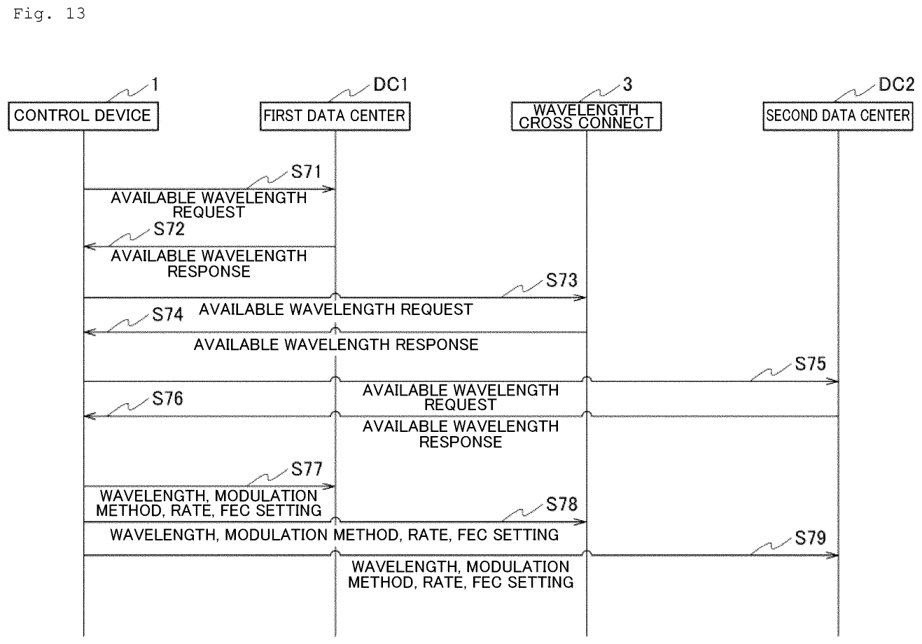

A process of preparing to establish an optical path between the first data center and the second data center will be described with reference to FIG. 13. This process corresponds to the processes of steps S7a, S7b, and S7c in FIG. 10.

In step S71, the control device 1 requests the first data center DC1 for a wavelength available for the movement of the resource to be moved. In step S72, the first data center DC1 responds to the control device 1 with the wavelength available in the first data center DC1.

In step S73, the control device 1 requests a wavelength available in the wavelength cross connect 3. In step S74, the wavelength cross connect 3 responds to the control device 1 with the wavelength available in the wavelength cross connect 3.

In step S75, the control device 1 requests a wavelength available in the second data center DC2. In step S76, the second data center DC2 responds to the control device 1 with the wavelength available in the second data center DC2.

The control device 1 specifies a common wavelength among the available wavelengths received in step S72, step S74, and step S76. In step S77, the control device 1 transmits the specified wavelength as well as the modulation method, rate, and FEC setting to the first data center DC1. In step S78, the control device 1 transmits the specified wavelength as well as the modulation method, rate, and FEC setting to the wavelength cross connect 3. In step S79, the control device 1 transmits the specified wavelength as well as the modulation method, rate, and FEC setting to the second data center DC2.

Through the process of FIG. 13, an optical path is established between the first data center DC1 and the second data center DC2 as shown in steps S8 and S9 in FIG. 10 under control of the control device 1.

The control device 1 in the present disclosure is connected to each data center, holds information relating to each data center, and supports the establishment of an optical path for moving to an appropriate data center in a case where a computing resource to be moved occurs.

Specifically, the control device 1 determines a data center which is a movement destination of a computing resource to be moved and an aggregation switch from information relating to each data center or the like. In order to move the computing resource to be moved, the control device 1 transmits an instruction for connection for the ports of the fiber cross connects of data centers which are a movement source and movement destination, and supports the establishment of an optical path within each data center. The control device 1 specifies the wavelength of an optical path to be established between the data centers which are a movement source and movement destination, notifies the data centers which are a movement source and movement destination, and the wavelength cross connect 3 of the specified wavelength, and supports the establishment of an optical path.

In a case where a computing resource to be moved occurs, the communication system 5 according to the present disclosure can establish a temporary optical path for moving a computing resource without using an optical path for DCI which is always connected. This makes it possible to optimally allocate computing resources without influencing normal traffic in the communication system 5.

In addition, the computing resource to be moved is converted into an optical signal and is moved using an optical path established within the data center. The communication system 5 can realize faster movement of large-capacity data than in a case where data moves within a data center as an electrical signal.

### Modification Example

Although a case where one computing resource is moved has been described in the embodiment, a case where two computing resources are moved will be described in a modification example.

In a case where there are a plurality of computing resources to be moved, the control device 1 specifies a data center which is a movement destination and an aggregation switch for each computing resource.

For a plurality of computing resources, in a case where the data center which is a movement source and the aggregation switch are the same as the data center which is a movement destination and the aggregation switch, the communication system 5 may establish one optical path each at the data center which is a movement source, between the data centers, and at the data center which is a movement destination, and the plurality of computing resources may be moved using the optical paths. Alternatively, for each of the plurality of computing resources, the communication system 5 establishes one optical path each at the data center, which is a movement source, between the data centers, and at the data center which is a movement destination, and a certain computing resource may be moved using the optical paths established for the computing resource.

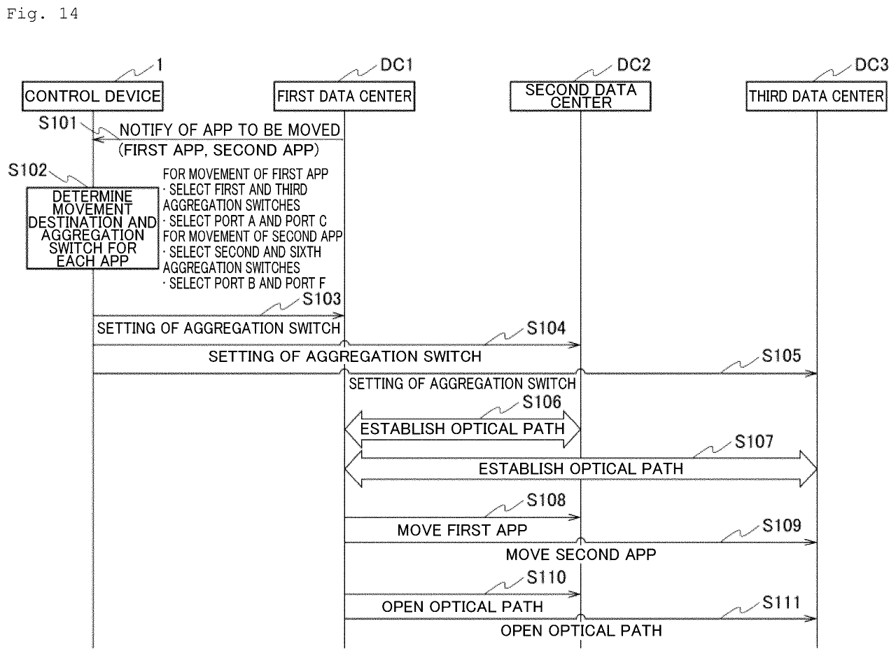

A process of preparing to establish optical paths between the first data center DC1, the second data center DC2, and the third data center DC3 will be described with reference to FIG. 14. In FIG. 14, a process to move the computing resource from the first data center DC1 in parallel to the second data center DC2 and the third data center DC3 will be described.

In step S101, the first data center DC1 notifies the control device 1 of applications to be moved. The applications to be moved are referred to as a first APP and a second APP.

In step S102, the control device 1 determines a data center which is a movement destination of the first APP and an aggregation switch to be connected to a server of the data center which is its movement destination.

Here, the control device 1 sets the movement destination for the first APP as the second data center DC2, and selects the first aggregation switch 106a as the aggregation switch which is a movement source and the third aggregation switch 206a as the aggregation switch which is a movement destination. In addition, the control device 1 selects the port A and the port C. The port A is a port of the fiber cross connect 104 connected to the first aggregation switch 106a. The port C is a port of the fiber cross connect 204 connected to the third aggregation switch 206a.

The control device 1 sets the movement destination for the second APP as the third data center DC3, and selects the second aggregation switch 106b as the aggregation switch which is a movement source and the sixth aggregation switch 306b as the aggregation switch which is a movement destination. In addition, the control device 1 selects the port B and the port F. The port B is a port of the fiber cross connect 104 connected to the second aggregation switch 106b. The port F is a port of the fiber cross connect 304 connected to the sixth aggregation switch 306b.

In step S103, the control device 1 transmits, to the first data center DC1, an instruction for connection to the port A connected to the first aggregation switch 106a. The fiber cross connect 104 of the first data center DC1 is connected to the port A in accordance with the processing shown in FIG. 11. The first data center DC1 establishes an optical path between the first aggregation switch 106a and the optical wavelength filter 101. In addition, the control device 1 transmits, to the first data center DC1, an instruction for connection to the port B connected to the second aggregation switch 106b. The fiber cross connect 104 of the first data center DC1 is connected to the port B similarly to the process shown in FIG. 11. The first data center DC1 establishes an optical path between the second aggregation switch 106b and the optical wavelength filter 101.

In step S104, the control device 1 transmits, to the second data center DC2, an instruction for connection to the port C connected to the third aggregation switch 206a. The fiber cross connect 204 of the second data center DC2 is connected to the port C in accordance with the processing shown in FIG. 12. The second data center DC2 establishes an optical path between the third aggregation switch 206a and the optical wavelength filter 201.

In step S105, the control device 1 transmits, to the third data center DC3, an instruction for connection to the port F connected to the sixth aggregation switch 306b. The fiber cross connect 304 of the third data center DC3 is connected to the port F similarly to the processing shown in FIG. 12. The third data center DC3 establishes an optical path between the sixth aggregation switch 306b and an optical wavelength filter 301.

In step S106, an optical path is established between the first data center DC1 and the second data center DC2 in accordance with the processing shown in FIG. 13 and the like. Similarly, in step S107, an optical path is established between the first data center DC1 and the third data center DC3.

In step S108, the first APP is moved using the optical paths established in step S103, step S104, and step S106. In step S109, the second APP is moved using the optical paths established in step S103, step S105, and step S107.

When the movement of the first APP is completed, in step S110, the optical paths established in step S103, step S104, and step S106 are opened. When the movement of the second APP is completed, in step S111, the optical paths established in step S103, step S105, and step S107 are opened.

FIG. 14 illustrates the processing in which the computing resource is moved from the first data center DC1 in parallel to the second data center DC2 and the third data center DC3, but there is no limitation thereto. In another embodiment, after the computing resource is moved from the first data center DC1 to the second data center DC2, another computing resource may be moved from the first data center DC1 to the third data center DC3.

Note that, in the present disclosure, any method of moving a computing resource can be used. For example, in a case where the computing resource is a virtual machine, the virtual machine may be moved by cold migration, or may be moved by live migration.

The control device 1 of the present embodiment described above uses, for example, a general-purpose computer system including the central processing unit (CPU, processor) 901, the memory 902, the storage 903 (hard disk drive (HDD), solid state drive (SSD)), a communication device 904, an input device 905, and an output device 906. In this computer system, each function of the control device 1 is realized by the CPU 901 executing a program loaded onto the memory 902.

Note that the control device 1 may be implemented in one computer, or may be implemented in a plurality of computers. In addition, the control device 1 may be a virtual machine implemented in a computer.

The program for the control device 1 can also be stored in a computer-readable recording medium such as an HDD, an SSD, a universal serial bus (USB) memory, a compact disc (CD), or a digital versatile disc (DVD), or can be distributed through a network. The computer-readable recording medium is, for example, a non-transitory recording medium.

Note that the present disclosure is not limited to the above embodiment, and various modifications are possible within the scope of the present disclosure.

### REFERENCE SIGNS LIST

1 Control device
2 Communication network
3 Wavelength cross connect
5 Communication system
11 Power data
12 Optical link data
13 Computing resource data
14 Equipment data
16 Target resource ID
17 Movement destination ID
21 Acquisition unit
22 Determination unit
23 Movement support unit
24 Switch setting unit
25 Path establishment support unit
101, 201, 301 Optical wavelength filter
102, 202, 302 Transponder
103, 203, 303 Edge router
104, 204, 304 Fiber cross connect
105, 205, 305 Server group
106, 206, 306 Aggregation switch
901 CPU
902 Memory
903 Storage
904 Communication device
905 Input device
906 Output device
DC Data center

1. A communication system comprising:
a plurality of data centers;
a cross connect configured to connect each data center through an optical path; and
control circuitry connected to each of the plurality of data centers and the cross connect,
wherein, in a case where a computing resource to be moved operating in a first data center is moved to a second data center,
the control circuitry includes path establishment support circuitry configured to specify a wavelength available in the first data center, the cross connect, and the second data center, and to notify the first data center, the cross connect, and the second data center of a specified wavelength,
the communication system establishes an optical path from the first data center through the cross connect to the second data center at the specified wavelength, and
the first data center moves the computing resource to be moved using the optical path established from the first data center to the second data center.
wherein a route of an optical path in the first data center of the optical path established from the first data center to the second data center is different from a route of an optical path for processing traffic that normally occurs in the first data center.

2. (canceled)

3. The communication system according to claim 1, wherein:
the first data center and the second data center each include a fiber cross connect configured to output an optical signal input from an input port to an output port.
the control circuitry further includes switch setting circuitry configured to
transmit, to the first data center, an instruction for connection to an output port connected to an aggregation switch to which a server accommodating the computing resource to be moved is connected, among output ports of a fiber cross connect of the first data center. and
transmit, to the second data center, an instruction for connection to an output port connected to an aggregation switch to which a server accommodating the computing resource to be moved is connected, among output ports of a fiber cross connect of the second data center.

4. The communication system according to claim 1, wherein the control circuitry further includes:
a memory
optical link data including specifications of optical links between data centers; and
computing resource data for associating a delay request and a data capacity for each computing resource; and
determination circuitry configured to refer to the optical link data and the computing resource data and determine a data center that is a movement destination, the data center that is the movement destination connecting to the first data center with the optical link having the specification which satisfies requirements for a delay request and a data capacity of the computing resource to be moved.

5. A communication method used in a communication system including:
a plurality of data centers;
a cross connect configured to connect each data center through an optical path; and
control circuitry connected to each of the plurality of data centers and the cross connect.
wherein, in a case where a computing resource to be moved operating in a first data center is moved to a second data center,
the control circuitry specifies a wavelength available in the first data center, the cross connect, and the second data center and notifies the first data center, the cross connect, and the second data center of a specified wavelength,
an optical path from the first data center through the cross connect to the second data center is established at the specified wavelength, and
the first data center moves the computing resource to be moved using the optical path established from the first data center to the second data center.
wherein a route of an optical path in the first data center of the optical path established from the first data center to the second data center is different from a route of an optical path for processing traffic that normally occurs in the first data center.

6. A control device comprising:
a memory optical link data including specifications of optical links between data centers; and
computing resource data for associating a delay request and a data capacity for each computing resource; and
determination circuitry configured to refer to the optical link data and the computing resource data and determine a data center that is a movement destination, the data center that is the movement destination connecting to a data center accommodating the computing resource to be moved with the optical link having the specification which satisfies requirements for a delay request and a data capacity of the computing resource to be moved.

7. A recording non-transitory computer readable medium storing a program processing program, where the program causes one or more computers to perform operations as the control device according to claim 6.

8. The communication system according to claim 1, wherein,
when the instruction for connection is received from the control circuitry, the first data center connects an output port to an aggregation switch connected to a server in which the computing resource to be moved is accommodated, and establishes an optical path between the aggregation switch connected to the server in which the computing resource to be moved is accommodated and an optical wavelength filter,
when the instruction for connection is received from the control circuitry, the second data center connects an output port to an aggregation switch of a server in which the computing resource to be moved is accommodated, and establishes an optical path between the aggregation switch connected to the server in which the computing resource to be moved is accommodated and an optical wavelength filter, and
the first data center moves the computing resource to be moved using the optical path established within the first data center, the optical path established from the first data center to the second data center, and the optical path established within the second data center.

9. The communication system according to claim 3, wherein,
when the computing resource to be moved is moved,
the first data center stops transmission and reception of an optical signal at the output port designated by the instruction for connection from the control circuitry, and
the second data center stops transmission and reception of an optical signal at the output port designated by the instruction for connection from the control circuitry.

10. The communication system according to claim 3, wherein,
when the computing resource to be moved is moved,
the first data center puts a coherent transceiver function in the aggregation switch on standby, wherein the aggregation switch is connected to a server accommodating the computing resources to be moved, and
the second data center puts a coherent transceiver function in the aggregation switch on standby, wherein the aggregation switch is connected to a server newly accommodating the computing resources to be moved.

11. The communication system according to claim 4, wherein,
the memory stores power data related to power consumed by each data center,
the determination circuitry configured to further refer to the power data and determine the data center that is the movement destination using a power index related to the power consumed by the data center.
